(19) United States
(12) Patent Application Publication
(10) Pub. No.: US 2015/0193727 A1
(43) Pub. Date: Jul. 9, 2015

(54) METHOD FOR PACK SIZE ALLOCATION WITH EXPIRY DATES

(71) Applicant: INTERNATIONAL BUSINESS MACHINES CORPORATION, ARMONK, NY (US)

(72) Inventor: Hisham E. Elshishiny, Cairo (EG)

(73) Assignee: INTERNATIONAL BUSINESS MACHINES CORPORATION, ARMONK, NY (US)

(21) Appl. No.: 14/148,866

(22) Filed: Jan. 7, 2014

(51) Int. Cl. G06Q 10/08

(52) U.S. Cl. CPC G06Q 10/087; G06Q 10/083

(57) ABSTRACT

A method for allocating a plurality of product packs corresponding to a product located at a central warehouse is provided. The method may include sorting the plurality of product packs based on a product pack expiry date. The method may include, allocating at least one product pack having a product amount within the sorted plurality of product packs to at least one shipping destination location, the allocating of the at least one product pack occurring prior to a pre-determined threshold value associated with the product amount being exceeded, wherein the allocating is performed according to a sequence based on the sorting of the plurality of product packs and a plurality of orders for the product. The method may include searching the sorted plurality of product packs for at least one additional product pack to be allocated. The method may include allocating the at least one additional product pack.

### FIELD OF THE INVENTION

The present invention relates generally to the field of computing, and more particularly to product shipment.

### BACKGROUND

In many supply chain situations, supplies such as food and medicines may be stored in a central warehouse. The supplies may be distributed for consumption to destination locations, according to shipment quantity determination, according to scheduling methods, and based on the demand in destination locations. Typically, the optimal recommended shipment quantities to individual destination locations may be determined in terms of an overall quantity of the supplies. Additionally, prior to shipment, it may be necessary to convert these quantities into numbers of available product pack sizes that are compatible with the available central warehouse pack size inventory. However, an expiry date may be associated with every product pack for many of the supplies, such as food and drugs, which makes the process of shipping these products more complicated. Therefore, it may become very difficult to reduce deviations, in either direction, between the recommended shipment quantity and the quantity actually shipped. Furthermore, it may become very difficult to reduce the likelihood of a product pack expiring before the product pack is actually shipped.

### SUMMARY

A method for allocating a plurality of product packs located at a central Warehouse is provided. The method may include sorting the plurality of product packs based on a product pack expiry date. The method may also include allocating at least one product pack having a product amount within the sorted plurality of product packs to at least one shipping destination location within a plurality of shipping destinations, the allocating of the at least one product pack occurring prior to a pre-determined threshold value associated with the product amount being exceeded, wherein the allocating is performed according to a sequence based on the sorting of the plurality of product packs and a plurality of orders for the product. The method may further include searching, prior to the pre-determined threshold value being exceeded by the allocating, the sorted plurality of product packs for at least one additional product pack to be allocated, wherein the sum of the at least one allocated product pack and the at least one additional product pack is less than or equal to a pre-determined shipment plus or minus the pre-determined threshold value. Additionally, the method may include allocating the at least one additional product pack to the at least one shipping location.

A computer system for allocating a plurality of product packs corresponding to a product located at a central warehouse is provided. The computer system may include one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method. The method may include sorting the plurality of product packs based on a product pack expiry date. The method may also include allocating at least one product pack having a product amount within the sorted plurality of product packs to at least one shipping destination location within a plurality of shipping destinations, the allocating of the at least one product pack occurring prior to a pre-determined threshold value associated with the product amount being exceeded, wherein the allocating is performed according to a sequence based on the sorting of the plurality of product packs and a plurality of orders for the product. The method may further include searching, prior to the pre-determined threshold value being exceeded by the allocating, the sorted plurality of product packs for at least one additional product pack to be allocated, wherein the sum of the at least one allocated product pack and the at least one additional product pack is less than or equal to a pre-determined shipment plus or minus the pre-determined threshold value. Additionally, the method may include allocating the at least one additional product pack to the at least one shipping location.

A computer program product for allocating a plurality of product packs corresponding to a product located at a central warehouse is provided. The computer program product may include one or more computer-readable storage devices and program instructions stored on at least one of the one or more tangible storage devices, the program instructions executable by a processor. The computer program product may include program instructions to sort the plurality of product packs based on a product pack expiry date. The computer program product may also include program instructions to allocate at least one product pack having a product amount within the sorted plurality of product packs to at least one shipping destination location within a plurality of shipping destinations, the allocating of the at least one product pack occurring prior to a pre-determined threshold value associated with the product amount being exceeded, wherein the allocating is performed according to a sequence based on the sorting of the plurality of product packs and a plurality of orders for the product. The computer program product may further include program instructions to search, prior to the pre-determined threshold value being exceeded by the allocating, the sorted plurality of product packs for at least one additional product pack to be allocated, wherein the sum of the at least one allocated product pack and the at least one additional product pack is less than or equal to a pre-determined shipment plus or minus the pre-determined threshold value. Additionally, computer program product may include program instructions to allocate the at least one additional product pack to the at least one shipping location.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 illustrates an example of pack size allocation with expiry dates according to at least one embodiment;

FIG. 3 is an operational flowchart illustrating the steps carried out by a program for pack size allocation with expiry dates; and

FIG. 4 is a block diagram of internal and external components of computers and servers depicted in FIG. 1.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly to product shipment. The following described exemplary embodiments provide a system, method and program product to reduce deviations, in either direction, between the recommended shipment quantity of supplies and the quantity of supplies actually shipped, as well as reduce the likelihood of a product pack expiry before shipping the product pack.

As previously described with respect to many supply chain situations, supplies, such as food and medicines, may be stored in a central warehouse. The supplies may be distributed for consumption to destination locations, according to shipment quantity determination, according to scheduling methods, and based on the demand in destination locations. Typically, the optimal recommended shipment quantities to individual destination locations may be determined in terms of an overall quantity of the supplies. For example, it may be determined that 2000 tablets should be sent to location “X” from drug “Y”. Additionally, prior to shipment, it may be necessary to convert these quantities into numbers of available product pack sizes that are compatible with the available central warehouse pack size inventory. For example, the 2000 tablets may be converted into 2 packs of 500 tablets and 4 packs of 250 tablets prior to shipment. However, an expiry date may be associated with every product pack for many of the supplies, such as food and drugs, which makes the process of shipping these products more complicated. Therefore, it may become very difficult to reduce deviations, in either direction, between the recommended shipment quantity and the quantity actually shipped. Furthermore, it may become very difficult to reduce the likelihood of a product pack expiring before the product pack is actually shipped. Current methods of distribution either do not take expiry dates into consideration or assume all product packs of the same size have the same expiry dates. As such, it may be advantageous, among other things, to provide a way to reduce deviations, in either direction, between the recommended shipment quantity of supplies and the quantity of supplies actually shipped, as well as reduce the likelihood of a product pack expiry before shipping the product pack.

According to at least one embodiment of the present invention, an interconnected two stage process may be implemented when each product that may be shipped from a central warehouse to final destinations is available in a number of pack sizes and each pack has its own expiry date. The interconnected two stage process may reduce deviations in either direction, between the recommended product shipment quantity and the quantity actually shipped from a central warehouse to final destination locations, and may reduce, as well, the likelihood of product packs expiry before their shipment. As such, the first stage may distribute product packs to destination shipment locations based on the expiry dates of the product packs in a way that balances the product packs' expiry among shipping destinations. Additionally, the second stage may work on reducing the total deviation from the recommended shipments destinations. As such, the likelihood of product packs expiry before shipping them from a central warehouse to final destinations may be reduced. Additionally, the difference between the actual shipments and the recommended shipments in terms of total quantities from central warehouses to final destinations may also be reduced. Furthermore, the product pack expiry dates may be balanced among the shipping destinations. Therefore, all the packs that are going to expire soon, may not be shipped to one destination, but rather evenly distributed among all the destinations along with a longer expiry date.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java and all Java-based trademarks and logos are trademarks or registered trademarks of Oracle and/or its affiliates), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following described exemplary embodiments provide a system, method and program product to reduce deviations, in either direction, between the recommended shipment quantity of supplies and the quantity of supplies actually shipped, as well as reduce the likelihood of a product pack expiry before shipping the product pack.

It may not be acceptable, prior to shipment, to keep product packs in a central store until they expire. Furthermore, every product to be shipped from a central warehouse to a final destination location may have multiple pack sizes; an expiry date for each single pack, and a recommended shipment quantity for a product from a central warehouse to any final location, may be larger than any pack size of this product. As such, according to at least one embodiment of the present invention, avoiding drug product pack expiry before shipping may have a higher priority than reducing deviations from the recommended shipment.

Embodiments of the present invention may include the following steps for pack size allocation:

1. Sort all available packs, for every product in the central store, according to their expiry dates in an ascending order (the product packs that will expire first are listed on the top, followed by those that will expire later).
2. For recommended product shipments (in terms of overall quantities such, as the total number of pills in case of a drug product,) from the central warehouse to a number of final destinations, the method may start by fulfilling these shipments by selecting in sequence from the sorted list of each product, the product packs listed on the top of the list followed by those that come later in the list. For a number of final destinations, the fulfillment may start by allocating for the first destination (selected in an arbitrary order), the first pack on the sorted list, and then the second pack may go to the second destination, etc. The method may select the next pack allocation to all destinations in a round robin manner.
3. Stop allocating packs to a destination, if the last selected pack to this destination will result in a difference from the recommended shipment larger than a +/− threshold (i.e., a value range) for this difference (the pack is not allocated in this case), or it will fulfill within the threshold the recommended shipment (the pack allocated in this case). Allocation of packs to the rest of the destinations may continue according to the same stop criterion until all destinations reach the stop criterion.
4. For each shipment that exceeds the threshold in step 3, the method may skip the order of the sorted packs on the list and search for a pack (among the remaining packs of the product on the list), that will fit the recommended destination quantity shipment (within the acceptable threshold). The method may then continue allocating packs to the other destination shipments according to this criterion, until all shipments are fulfilled, or there are no remaining packs, from this product, in the central warehouse. In case all remaining pack sizes results in a shipment difference larger than the acceptable threshold for a destination, the method may compare the shipment before and after adding each remaining pack size and the method may select the case that gives the smallest deviation from the recommended shipment.

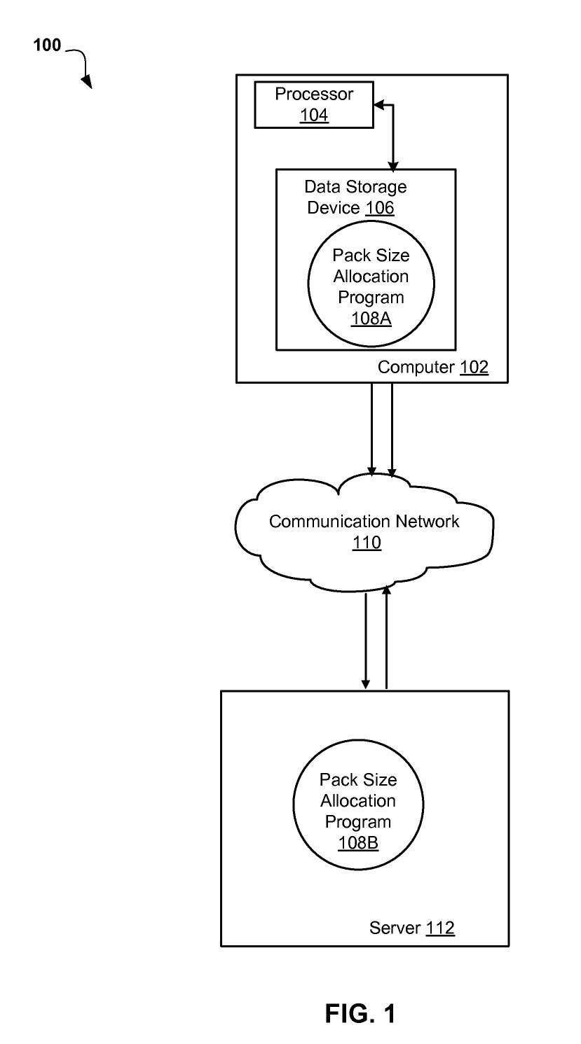

Referring now to FIG. 1, an exemplary networked computer environment 100 in accordance with one embodiment is depicted. The networked computer environment 100 may include a computer 102 with a processor 104 and a data storage device 106 that is enabled to run a pack size allocation program 108A. The networked computer environment 100 may also include a server 112 that is enabled to run a pack size allocation program 108B and a communication network 110. The networked computer environment 100 may include a plurality of computers 102 and servers 112, only one of which is shown for illustrative brevity. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

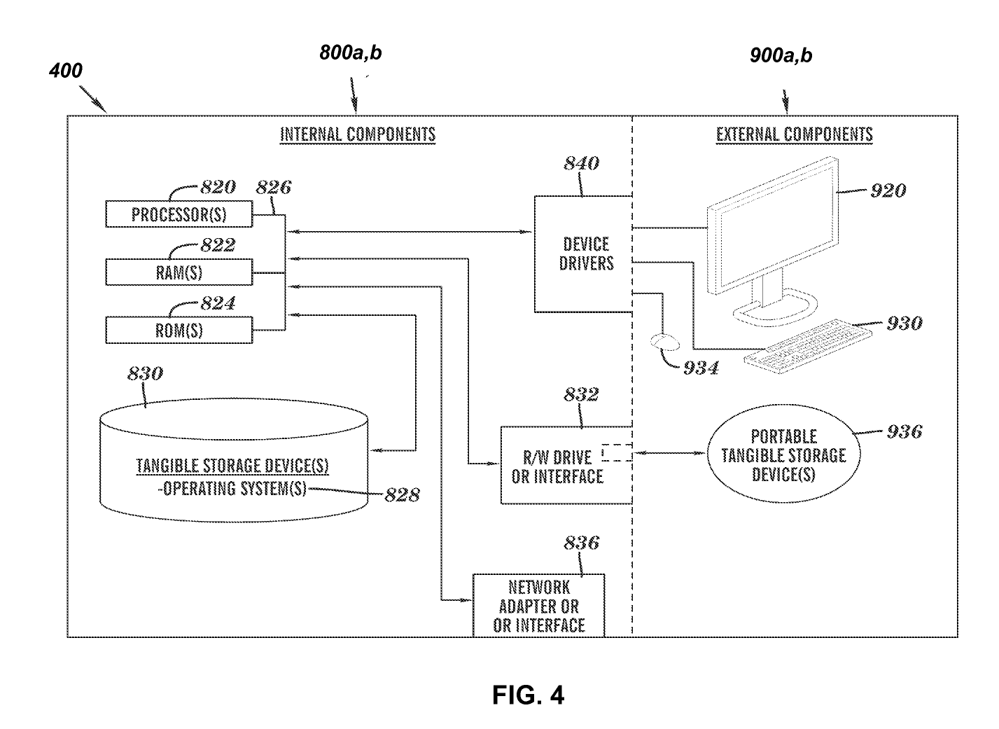

The client computer 102 may communicate with server computer 112 via the communications network 110. The communications network 110 may include connections, such as wire, wireless communication links, or fiber optic cables. As will be discussed with reference to FIG. 4, server computer 112 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program and accessing a network.

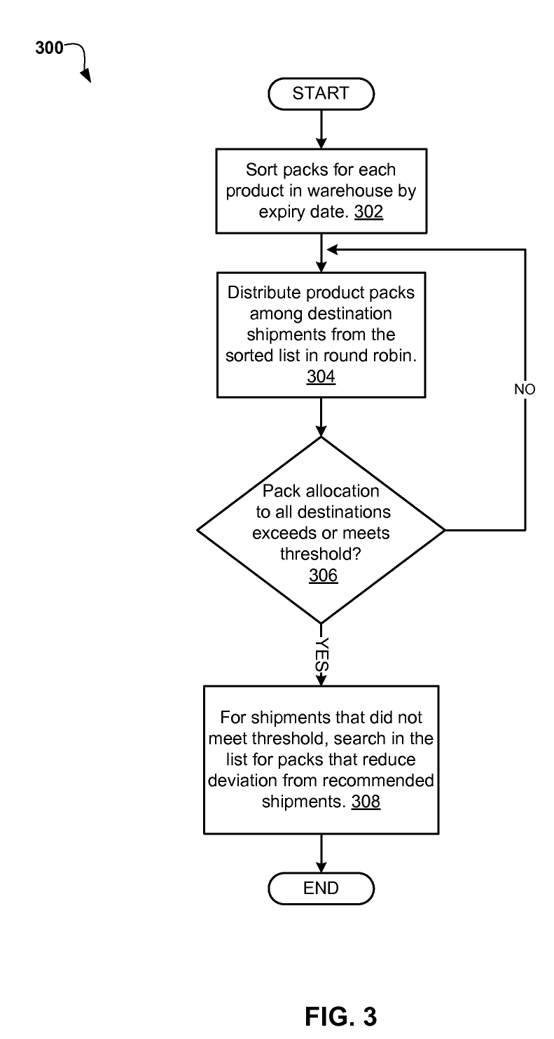

A program, such as a pack size allocation program 108A and 108B may run on the client computer 102 or on the server computer 112. The pack size allocation program 108A, 108B may be executed to reduce deviations, in either direction, between the recommended shipment quantity of supplies and the quantity of supplies actually shipped, as well as reduce the likelihood of a product pack expiry before shipping the product pack. For example, a user using a pack size allocation program 108A, running on a client computer 102 may connect via a communication network 110 to server computer 112 which may also be running a pack size allocation program 108B. Furthermore, the user using client computer 102 or server 112 may utilize the pack size allocation program 108A, 108B prior to distributing a shipment of supplies in order to reduce deviations, in either direction, between the recommended shipment quantity of supplies and the quantity of supplies actually shipped, as well as reduce the likelihood of a product pack expiry before shipping the product pack The pack size allocation method is explained in further detail below with respect to FIG. 3.

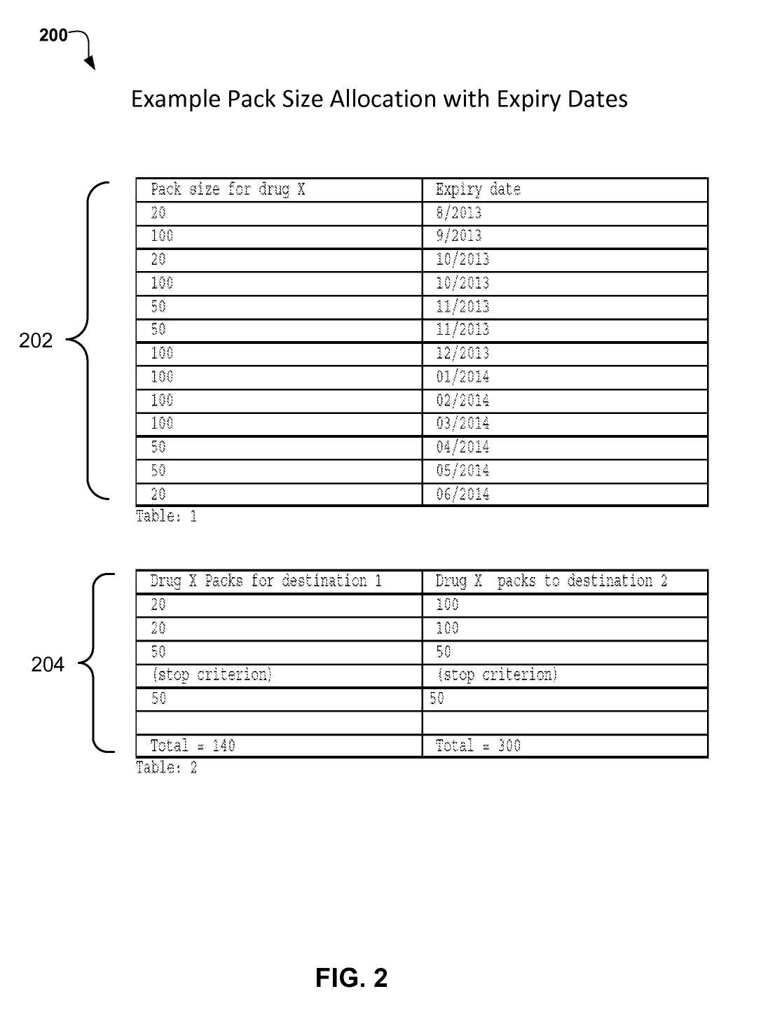

Referring now to FIG. 2, an example of pack size allocation with expiry dates according to at least one embodiment is depicted. For illustrative purposes only, it may be assumed that recommended shipments of 150 pills and 300 pills from drug “X” (as depicted in “Table 1” 202) to be shipped to final destinations “I” and “2” (as depicted in “Table 2” 204) respectively, and the pack list of drug “X” available in the central warehouse have been grouped as packs of 20, 50, and 100 and have been sorted according to the expiry date. Also, for illustrative purposes only, it may be assumed that a user determined threshold for the acceptable difference between the amount requested and the amount that may be shipped is +/−“10” (i.e., 140-160 for the recommended shipment of 150 and 290-310 for the recommended shipment of 300). Additionally, as depicted in “Table 1” 202 the pack size for drug “X” may be sorted according to expiry date.

A user using client computer 102 (FIG. 1) or server 112 (FIG. 1) may utilize the pack size allocation program 108A (FIG. 1), 108B (FIG. 1) to reduce deviations, in either direction, between the recommended shipment quantity of supplies and the quantity of supplies actually shipped, as well as reduce the likelihood of a product pack expiry before shipping the product pack. As such, the pack size allocation program 108A (FIG. 1), 108B (FIG. 1) may first select pack sizes for destinations 1 and 2 (as depicted in “Table 2” 204) from the drug “X” sorted list (as depicted in “Table 1” 202) in a round robin sequence as follows: a pack size of 20 may be allocated to destination 1; a pack size of 100 may be allocated to destination 2; a pack size of 20 may be allocated to destination 1; a pack size of 100 may be allocated to destination 2; a pack size of 50 may be allocated to destination 1; and a pack size of 50 may be allocated to destination 2.

2. The method may stop when the next pack allocation would exceed the pre-determined threshold value. Therefore, the method may allocate 20+20+50 for the first destination (as depicted in “Table 2” 204) then the method may stop allocating in sequence since the stop criterion was reached. The stop criterion may be determined when the next pack size allocation in the round robin order would exceed the pre-determined threshold value. With respect to the current example, the next allocation to destination 1 would be 100, which when added to the sum of the previously allocated packs of 90, would make the shipment total for destination 1 equal to 190. As such, 190 (sum of pack contents) would exceed the pre-determined shipment of 150+/− the threshold value of +/−10 (i.e. within 140-160 range) for destination 1 and therefore, the method may stop allocating packs according to the round robin sequence. Similarly, the method may allocate 100+100+50 for destination 2 (as depicted in “Table 2” 204) and then the method may stop as the stop criterion was reached. With respect to the current example, the next allocation to destination 2 would be 100, making the shipment total for destination 2 equal to 350 which would exceed the pre-determined shipment of 300+/− threshold value of +/−10 (i.e. within 290-310 range) for destination 2.

After the stop criterion is reached, the pack size allocation program 108A (FIG. 1), 108B (FIG. 1) may search the drug “X” sorted list (as depicted in “Table 1” 202) and select a pack size that will be within the pre-determined threshold value of +/−10. For example, the method may search in the list and select a pack size of 50 and allocate the pack size of 50 to destination 2 (as depicted in “Table 2” 204). This may allow for the shipment to exactly fit the recommended shipment quantity of 300 since 100+100+50=250 previously allocated via round robin to destination 2 and 250+50=300 which is within the pre-determined threshold of 190-310 for destination 2. Similarly, the method may search in the list and select a pack size of 50 and allocate the pack size of 50 to destination 1 (as depicted in “Table 2” 204). This may allow for the shipment to be within the acceptable threshold of +/−10 of the recommended shipment quantity of 150 since 20+20+50=90 previously allocated via round robin to destination 1 and 90+50=140 which is within the pre-determined threshold of 140-160 for destination 1.

Referring now to FIG. 3, an operational flowchart illustrating the steps carried out by a program for pack size allocation with expiry dates according to at least one embodiment is depicted. For example, the pack size allocation program 108A, 108B (FIG. 1) may be implemented as running on a client computer 102 (FIG. 1) or server computer 112 (FIG. 1). A user using client computer 102 (FIG. 1) or server computer 112 (FIG. 1) may execute the pack size allocation program 108A, 108B (FIG. 1). As previously explained, it may not be acceptable, prior to shipment, to keep product packs in a central store until they expire. Additionally, every product to be shipped from a central warehouse to a final destination location may have multiple pack sizes; an expiry date for each single pack, and a recommended shipment quantity for a product from a central warehouse to any final location, may be larger than any pack size of this product. As such, according to at least one embodiment of the present invention, avoiding drug product pack expiry before shipping may have a higher priority than reducing deviations from the recommended shipment.

Furthermore, according to at least one embodiment of the present invention, the pack expiry date may be considered as the date indicated on the pack minus a value that corresponds to the maximum travel duration from the central warehouse to destination locations since the product may not be consumed during transportation from the central warehouse to the destination location. As such, according to at least one implementation, and for purposes of explaining the pack size allocation method with respect to FIG. 3, all packs with this expiry date that is before or equal to the current date may be removed first from the warehouse before the sorting of the pack size according to expiry date.

Referring now to FIG. 3 at 302, the packs for each product in a warehouse (i.e., a plurality of product packs) may be sorted by expiry date. For example, the pack size allocation program 108A, 108B (FIG. 1) may sort all available packs, for every product in the central store, according to their expiry dates in a ascending order (the product packs that will expire first may listed on the top, followed by those that will expire later) as depicted in “Table 1” 202 (FIG. 2). As such, the sorting may enable a balancing of a plurality of product pack expiry dates among the plurality of shipping destinations so that a single shipping destination may not a receive a majority of product packs with expiry dates expiring at the same time.

Additionally, according to at least one implementation, the product pack expiry date may be a date indicated on the plurality of product packs minus a value that corresponds to a maximum travel duration from the central warehouse to the at least one destination location. Furthermore, according to at least one implementation, the sorting may include a removal of a product pack with an expiry date that is before or equal to a current date from the warehouse prior to the sorting.

Next, at 304, product packs may be distributed among destination shipments from the sorted list in a round robin sequence. As such, at least one product pack having a product amount within the sorted plurality of product packs may be allocated to at least one shipping destination location within a plurality of shipping destinations based on a shipment request from the at least one shipping destination. Furthermore, the allocating of the at least one product pack may occur prior to a pre-determined threshold value associated with the product amount being exceeded, wherein the allocating is performed according to a sequence based on the sorting of the product packs according to their expiry dates and a plurality of orders for the product. For recommended product shipments (in terms of overall quantities such, as the total number of pills in case of a drug product,) from the central warehouse to a number of final destinations, the method may start by fulfilling these shipments by selecting in a sequence from the sorted list of each product, the product packs listed on the top of the list followed by those that come later in the list. For a number of final destinations, the fulfillment may start by allocating for the first destination (selected in an arbitrary order), the first pack on the sorted list, and then the second pack may go to the second destination, etc. The method may select the next pack allocation to all destinations in a round robin manner. As such, the method may return back to the first destination after the method has finished allocating a shipment of packs to the last destination. According to one implementation, the method may continue this process until stop criteria (i.e., a threshold) is reached. The threshold is explained in more detail with respect to step 306.

Next, at 306, it is determined whether the pack allocation to all destinations exceeds or meets a pre-determined threshold value (i.e., a pre-determined range within a specified difference for the requested shipment). According to at least one implementation, the pre-determined threshold value may be a value range difference generated based on a shipment request value associated with the at least one shipping destination.

As such, according to one implementation, the method may stop allocating packs to a destination, if the last selected pack to this destination will result in a difference from the recommended shipment larger than an arbitrary, user determined (i.e., pre-determined threshold value)+/− threshold for this difference for each shipment. Therefore, either the pack is not allocated in this case, or the method may fulfill within the pre-determined threshold value the recommended shipment so that the pack is allocated in this case. For example, a destination may have requested a shipment of 200 pills. The method may have allocated 107 pills and the next pack to be distributed is 100 pills. The method may allocate 207 (i.e., 107+100) for the shipment since the threshold was +/−10 from 200 (i.e., 190-210 range) and 207 is within the range of 190-210. Similarly, the method may not allocate a next pack of 150 since 257 (i.e., 107+150) would exceed the threshold of +/−10 from 200. Allocation of packs to the rest of the destinations may continue at step 302 according to the same stop criterion until all destinations reach the stop criterion. If it is determined that the pack allocation to all destinations exceeds or meets the pre-determined threshold value, then the method continues to step 308.

Next, at 308, for shipments that did not meet the threshold, the method may search in the list for packs that reduce deviation from the recommended shipments. As such, prior to the pre-determined threshold value being exceeded by the allocating, the method may search the sorted plurality of product packs for at least one additional product pack to be allocated. The sum of the at least one allocated product pack and the at least one additional product pack may be less than or equal to the pre-determined shipment quantity +/− the pre-determined threshold value. Then the method may allocate the at least one additional product pack to the at least one shipping location.

For example, for each shipment that exceeds the threshold (in step 306), the method may skip the order of the sorted packs on the list and search for a pack (among the remaining packs of the product on the list), that will fit the recommended destination quantity shipment (within the acceptable threshold). Then the method may, continue allocating packs to the other destination shipments according to this criterion, until all shipments are fulfilled, or there are no remaining packs, from this product, in the central warehouse. According to one implementation, in case all remaining pack sizes results in a shipment difference larger than the acceptable threshold for a destination, the method may compare the shipment before and after adding each remaining pack size and the method may select the case that gives the smallest deviation from the recommended shipment. Then, according to at least one implementation, the at least one allocated product pack and the at least one allocated additional product pack may be distributed to the at least one shipping destination.

FIG. 4 is a block diagram of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 4. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and pack size allocation program 108A (FIG. 1) in client computer 102 and pack size allocation program 108B in network server computer 112 are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as pack size allocation program 108A and 108B, can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The pack size allocation program 108A in client computer 102 and pack size allocation program 108B in network server 112 can be downloaded to client computer 102 from an external computer via a network (for example, the Internet, a local area network or other, wide area network) and respective network adapters or interfaces 836. From the network adapters or interfaces 836, the pack size allocation program 108A in client computer 102 and the pack size allocation program 108B in network server computer 112 are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1.-8. (canceled)

9. A computer system for allocating a plurality of product packs corresponding to a product located at a central warehouse, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
sorting the plurality of product packs based on a product pack expiry date;
allocating at least one product pack having a product amount within the sorted plurality of product packs to at least one shipping destination location within a plurality of shipping destinations, the allocating of the at least one product pack occurring prior to a pre-determined threshold value associated with the product amount being exceeded, wherein the allocating is performed according to a sequence based on the sorting of the plurality of product packs and a plurality of orders for the product;
searching, prior to the pre-determined threshold value being exceeded by the allocating, the sorted plurality of product packs for at least one additional product pack to be allocated, wherein the sum of the at least one allocated product pack and the at least one additional product pack is less than or equal to a pre-determined shipment plus or minus the pre-determined threshold value; and
allocating the at least one additional product pack to the at least one shipping location.

10. The computer system of claim 9, further comprising:
distributing the at least one allocated product pack and the at least one allocated additional product pack to the at least one shipping destination.

11. The computer system of claim 9, wherein the sequence comprises distributing the plurality of orders for the product in a round robin sequence.

12. The computer system of claim 9, wherein the allocating of the sorted plurality of product packs is based on a shipment request from the at least one shipping destination.

13. The computer system of claim 9, wherein the product pack expiry date comprises a date indicated on the plurality of product packs minus a value that corresponds to a maximum travel duration from the central warehouse to the at least one destination location.

14. The computer system of claim 9, wherein the sorting comprises a removal of a product pack with an expiry date that is before or equal to a current date from the warehouse prior to the sorting.

15. The computer system of claim 9, wherein the sorting comprises a balancing of a plurality of product pack expiry dates among the plurality of shipping destinations.

16. The computer system of claim 9, wherein the pre-determined threshold value comprises a value range difference generated based on a shipment request value associated with the at least one shipping destination.

17. A computer program product for allocating a plurality of product packs corresponding to a product located at a central warehouse, comprising:
one or more computer-readable storage devices and program instructions stored on at least one of the one or more tangible storage devices, the program instructions executable by a processor, the program instructions comprising:
program instructions to sort the plurality of product packs based on a product pack expiry date;
program instructions to allocate at least one product pack having a product amount within the sorted plurality of product packs to at least one shipping destination location within a plurality of shipping destinations, the allocating of the at least one product pack occurring prior to a pre-determined threshold value associated with the product amount being exceeded, wherein the allocating is performed according to a sequence based on the sorting of the plurality of product packs and a plurality of orders for the product;
program instructions to search, prior to the pre-determined threshold value being exceeded by the allocating, the sorted plurality of product packs for at least one additional product pack to be allocated, wherein the sum of the at least one allocated product pack and the at least one additional product pack is less than or equal to a pre-determined shipment plus or minus the pre-determined threshold value; and
program instructions to allocate the at least one additional product pack to the at least one shipping location.

18. The computer program product of claim 17, further comprising:
distributing the at least one allocated product pack and the at least one allocated additional product pack to the at least one shipping destination.

19. The computer program product of claim 17, wherein the sequence comprises distributing the plurality of orders for the product in a round robin sequence.

20. The computer program product of claim 17, wherein the allocating of the sorted plurality of product packs is based on a shipment request from the at least one shipping destination.
